(19) United States
(12) Patent Application Publication
(10) Pub. No.: US 2007/0063861 A1
(43) Pub. Date: Mar. 22, 2007

(54) Method And Apparatus For Personal Security

(75) Inventor: Lung-Chun Chang, Taipei (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Lite-On Technology Corp., Taipei (TW)

(21) Appl. No.: 11/530,436

(22) Filed: Sep. 8, 2006

(30) Foreign Application Priority Data
Sep. 16, 2005 (TW) 094132178

(51) Int. Cl. H04L 12/56; G08B 5/22

(52) U.S. Cl. 340/825.49; 370/389; 340/539.13

(57) ABSTRACT

A method and an apparatus for the personal security are provided. The method includes steps of (a) providing a portable personal security apparatus comprising a positioning system and an output displaying device for optionally executing a new message prompting function; (b) providing a specific message to the portable personal security apparatus; (c) identifying the specific message; (d) shutting off the new message prompting function of the portable personal security apparatus; (e) initiating the positioning system to obtain a positioning information of the portable personal security apparatus; and (f) transmitting the positioning information.

### FIELD OF THE INVENTION

The present invention relates to a method and an apparatus for the personal security, and more particularly to a method and an apparatus for the portable personal security.

### BACKGROUND OF THE INVENTION

The Global Positioning System (GPS) is originally used for positioning and coordination of military strength; however, due to its continuous development and improvement of the hardware and software, the GPS gradually applied to people's daily life.

For instance, the self-help tourist can position his own location with the assistance of GPS, and the golf player can be aware of the geography between the green belt and himself. Furthermore, the driver can gain the positioning information of the place near his current location, e.g. a restaurant location, a road location, etc., and adjust his driving route accordingly.

The most common application of the current GPS is to implant it into the mobile phone or Personal Digital Assistance (PDA) to enhance their application and give them the positioning function.

Generally speaking, if the user wants to obtain the positioning information through the GPS, he needs to use his own emitter to transmit a signal to the positioning satellite. After the computation, the signal is received by the receiver held by the GPS supplier, and then the user inquires about the positioning information (e.g. the position coordinate or geography, etc.) from the GPS supplier.

Because the GPS can accurately provide the position of the user or a specific object, beside the above-mentioned application, another important application field is in the protection of personal security, e.g. implanting the GPS into the so-called “assisted chasing bracelet” to provide the position information of the bracelet holder (e.g. the children, elderly and mountain climber). However, under certain conditions, due to its complicated process and lack of privacy, the above-mentioned method of providing the position information cannot bring the efficacy into full play. For instance, because the person to be positioned and the one wanting to obtain the positioning information respectively need to provide signals and inquire about the positioning information from the GPS supplier, they can not rapidly gain the information about the position of the person to be positioned. Furthermore, the above-mentioned method is to actively provide and obtain the position information, besides time consuming, when the person to be positioned loses his freedom (e.g. terrorized or wounded), he cannot actively provide signals to the GPS supplier. Thus, the above-mentioned method not only is complicated and possibly delays the timing of rescue, but also produces many limitations on the personal security application due to its information providing method.

In order to improve the flaws in the prior art, the inventors propose the present invention “Method and apparatus for personal security” after scrupulous study and steady effort. The present invention is to position a portable device in a passive way and to provide the positioning information of the portable personal security device in a private way. By using the method and apparatus for personal security of the present invention, the information about the position of the person to be positioned can be quickly gained and the personal security help can be provided thereto in time.

### SUMMARY OF THE INVENTION

In accordance with one aspect of the present invention, a method for a personal security is provided. The method includes steps of (a) providing a portable personal security apparatus comprising a positioning system and an output displaying device for optionally executing a new message prompting function; (b) providing a specific message to the portable personal security apparatus; (c) identifying the specific message; (d) shutting off the new message prompting function of the portable personal security apparatus; (e) initiating the positioning system to obtain a positioning information of the portable personal security apparatus; and (f) transmitting the positioning information.

Preferably, the specific message is transmitted from a portable apparatus at a remote site.

Preferably, the portable apparatus is a wireless communication apparatus.

Preferably, the positioning information is transmitted from the portable personal security apparatus to the portable apparatus.

Preferably, the portable personal security apparatus includes a wireless communication apparatus.

Preferably, the wireless communication apparatus is one selected from the group consisting of a cell phone, a pager and a Personal Digital Assistant.

Preferably, a content corresponding to the specific message is stored in the portable personal security apparatus in advance.

Preferably, the new message prompting function comprises at least one selected from the group consisting of a voice output displaying function, a character output displaying function and an image output displaying function.

Preferably, the positioning system is one of a Global Positioning System and an Assisted Global Positioning System.

In accordance with another aspect of the present invention, a personal security system is provided. The system includes a first wireless communication apparatus sending out a message; and a second wireless communication apparatus receiving the message, and comprising: a positioning system obtaining a positioning information of the second wireless communication apparatus; an output displaying device displaying the message; a storage device storing a content; and a control device electrically connected to the positioning system, the storage device and the output displaying device, comparing the message and the content to obtain a comparison result and controlling the output displaying apparatus to perform a selective display according to the comparison result.

Preferably, when the message contains the content, the control device controls the output-displaying device not to display a receipt of the message but to send out the positioning information.

Preferably, the output-displaying device transmits the positioning information in a Short Message Service form.

Preferably, the positioning information is transmitted to the first wireless communication apparatus.

Preferably, when the message does not contain the content, the control device controls the output-displaying device to display a receipt of the message.

Preferably, each of the first and second wireless communication apparatuses is one selected from the group consisting of a cell phone, a pager and a Personal Digital Assistant.

Preferably, the output displaying device has at least one selected from the group consisting of a voice output displaying function, a character output displaying function and an image output displaying function.

Preferably, the positioning system is one of a Global Positioning System and an Assisted Global Positioning System.

The above aspects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1 illustrates the steps of the method for personal security according to a preferred embodiment of the present invention; and

FIG. 2 is a schematic diagram of the personal security system according to a preferred embodiment of the present invention.

### DETAILED DESCRIPTION OF THE PREFERRED EMBODIMENT

The present invention will now be described more specifically with reference to the following embodiments. It is noted that the following descriptions of preferred embodiments of this invention are presented herein for the purposes of illustration and description only; it is not intended to be exhaustive or to be limited to the precise form disclosed.

The method for personal security of the present invention is performed by a portable personal security device. The portable personal security device is a portable wireless communication device, e.g. a mobile phone, a pager, or a Personal Digital Assistant (PDA), wherein a Global Positioning System (GPS) or an assisted Global Positioning System (A-GPS) is embedded in the portable wireless communication device.

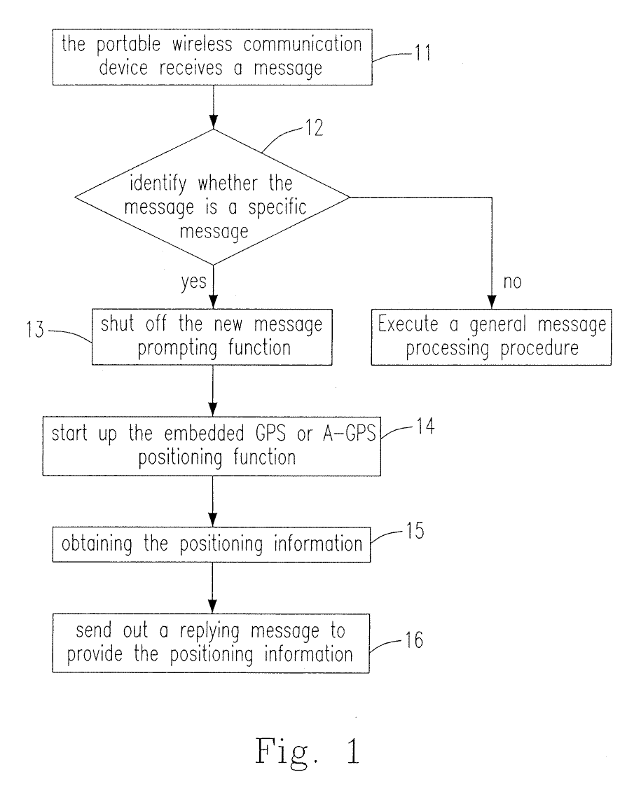

Please refer to FIG. 1, which illustrates the steps of the method for personal security according to a preferred embodiment of the present invention. When one needs to obtain the positioning information of the person who holds the portable wireless communication device, the portable wireless communication device first receives a message, as shown in step 11, wherein the message is sent out by a third person who holds a communication device at a remote site.

When the portable wireless communication device receives the message, it will perform an examination and a confirmation about the content of the message to identify whether the message is a specific seeking message, as shown in step 12. If the message is only a general communication message, then the portable wireless communication device will execute a general message processing procedure, e.g. sending out a certain sound, vibration or image by the output displaying device according to the new message prompting function set in the portable wireless communication device in advance, so as to prompt the user that a new message is received and to further display the content of the communication message for the user to execute the message storing, deleting or replying actions. If the message is a specific seeking message, then the portable wireless communication device will execute the following actions in a private way.

In this step, the identification of the type of the message can be achieved by examining whether the message contains a specific content. The specific content may be preset in the portable wireless communication device by the person who holds it or the third person at the remote site. The specific content is written in the message to be sent out by the third person for identification.

When the message is identified as a specific seeking message, the portable wireless communication device enters a private communication mode. In detail, the portable wireless communication device will automatically shut off or will not start up the above-mentioned new message prompting function, i.e. it will not prompt the user that a new message is received by a sound, vibration or image, as shown in step 13. After the new message prompting function is shut off, the portable wireless communication device will start up the embedded GPS or A-GPS positioning function to obtain the positioning information, as shown in step 14 and step 15 respectively. After obtaining the positioning information of the person who holds the portable wireless communication device, the device will send out a replying message automatically to transmit the positioning information to the third person at the remote site, as shown in step 16.

In this embodiment, the message transmission between the portable wireless communication device and the communication device held by the third person at the remote site is performed in a Short Message Service (SMS) way. Thus, both the portable wireless communication device and the communication device held by the third person at the remote site must support the above-mentioned SMS function. However, beside the SMS method, the message transmission can be preformed by using the communication device and other message service methods supported thereby.

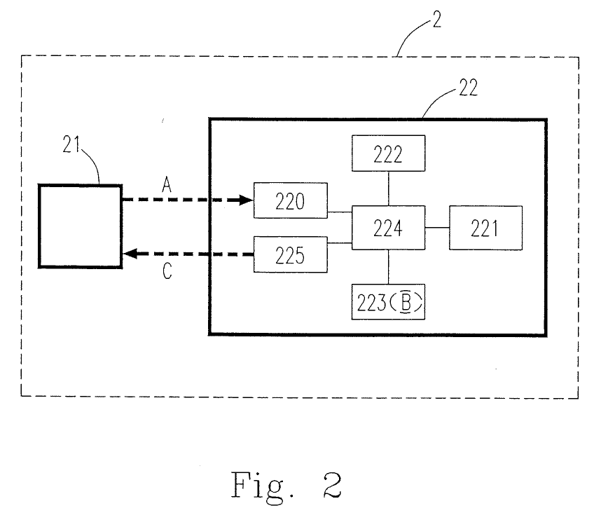

Please refer to FIG. 2, which is a schematic diagram of the personal security system according to a preferred embodiment of the present invention. The personal security system 2 comprises a first wireless communication device 21 and a second wireless communication device 22, wherein the first wireless communication device 21 is held by the third person at the remote site. When one needs to obtain the positioning information of the person who holds the second wireless communication device 22, the third person at the remote site transmits a message A to the second wireless communication device 22 by the first wireless communication device 21.

The second wireless communication device comprises a receiving device 220, a positioning system 221, an output displaying device 222, a storage device 223, a control device 224 and a transmitting device 225. The control device 224 is electrically connected to the receiving device 220, the positioning system 221, the output displaying device 222, the storage device 223 and the transmitting device 225, wherein a specific content B is stored in the storage device 223 in advance.

After the receiving device 220 in the second wireless communication device 22 receives the message A, the control device 224 performs the comparison between message A and content B, and controls the output displaying device 222 according to the comparison results to perform a selective display.

According to the comparison result, if message A is only a general communication message, then the control device 224 instructs the second wireless communication device 22 to execute a general message processing procedure, e.g. sending out a certain sound, vibration or image by the output displaying device 222 according to the new message prompting function preset in the output displaying device, so as to prompt the user that a new message is received and to further display the content of the communication message for the user to execute the message storing, deleting or replying actions. If message A contains content B pre-stored in the storing device 223, the control device 224 controls the output displaying device 22 not to display the receipt of message A and controls the transmitting device 225 to transmit privately the positioning information C obtained by the positioning system 221, so as to make the third person holding the first wireless communication device 21 obtain the positioning information C of the user holding the second wireless communication device 22 and thus confirm his action position.

Similarly, in this embodiment, the first and second wireless communication devices 21 and 22 are portable wireless communication devices, e.g. mobile phones, pagers, or PDAs. The positioning system 221 embedded in the second wireless communication device 22 is chosen from the GPS or A-GPS.

From the above descriptions, the most prominent feature of the present invention is that the positioning information is only transmitted privately between the portable communication device and the communication device at a remote site. Compared to the prior art, the present invention greatly reduces the time needed for positioning and providing the positioning information. Furthermore, because the transmission of the positioning information of the present invention is initiated by the third person at a remote site, when the apparatus holder cannot actively inform his position due to external factors (e.g. terrorized, wounded, etc.) or internal factors (e.g. loss of intelligence, loss of memory, disability, etc.), or even when it's necessary to call for help privately without causing attention of the outlaw, the present invention provides the necessary privacy and passive position searching method. Beside the above-mentioned applications, the present invention can be further used in the searching for missing people and the positioning of stolen articles (e.g. cars, mobile phones, etc.).

The personal security method of the present invention has many expansion forms in the execution procedure, which are designed according to the needed expansion functions. For instance, in the above-mentioned step 16, the positioning information can be transmitted to other relevant persons in message form, e.g. transmitted to the personnel of the police department or the searching assistance party to strive for the timing of rescue and searching. These expansion functions can be stored in a storage medium or written in a chip via a program, and they are all compatible with the present portable communication devices. Therefore, the present invention has practical implementing ability and fair application potential.

In conclusion, the present invention is indeed a novel, progressive invention and has industrial practicality and competitiveness, thus having great development value.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A method for a personal security, comprising steps of:
(a) providing a portable personal security apparatus comprising a positioning system and an output displaying device for optionally executing a new message prompting function;
(b) providing a specific message to the portable personal security apparatus;
(c) identifying the specific message;
(d) shutting off the new message prompting function of the portable personal security apparatus;
(e) initiating the positioning system to obtain a positioning information of the portable personal security apparatus; and
(f) transmitting the positioning information.

2. The method according to claim 1, wherein the specific message is transmitted from a portable apparatus at a remote site.

3. The method according to claim 2, wherein the portable apparatus is a wireless communication apparatus.

4. The method according to claim 2, wherein the positioning information is transmitted from the portable personal security apparatus to the portable apparatus.

5. The method according to claim 1, wherein the portable personal security apparatus includes a wireless communication apparatus.

6. The method according to claim 5, wherein the wireless communication apparatus is one selected from the group consisting of a cell phone, a pager and a Personal Digital Assistant.

7. The method according to claim 1, wherein a predetermined content is stored in the portable personal security apparatus for identifying the specific message.

8. The method according to claim 1, wherein the new message prompting function comprises at least one selected from the group consisting of a voice output displaying function, a character output displaying function and an image output displaying function.

9. The method according to claim 1, wherein the positioning system is one of a Global Positioning System and an Assisted Global Positioning System.

10. A personal security system, comprising:
a first wireless communication apparatus sending out a message; and
a second wireless communication apparatus receiving the message, and comprising:
a positioning system obtaining a positioning information of the second wireless communication apparatus;
an output displaying device selectively displaying the message;
a storage device storing a content; and
a control device electrically connected to the positioning system, the storage device and the output displaying device, comparing the message and the content to obtain a comparison result and controlling the output displaying apparatus to perform a selective display according to the comparison result.

11. The personal security system according to claim 10, wherein when the message contains the content, the control device controls the output displaying device not to display a receipt of the message but to send out the positioning information.

12. The personal security system according to claim 11, wherein the output displaying device transmits the positioning information in a Short Message Service form.

13. The personal security system according to claim 11, wherein the positioning information is transmitted to the first wireless communication apparatus.

14. The personal security system according to claim 10, wherein when the message does not contain the content, the control device controls the output displaying device to display a receipt of the message.

15. The personal security system according to claim 10, wherein each of the first and second wireless communication apparatuses are one selected from the group consisting of a cell phone, a pager and a Personal Digital Assistant.

16. The personal security system according to claim 10, wherein the Output displaying device has at least one selected from the group consisting of a voice output displaying function, a character output displaying function and an image output displaying function.

17. The personal security system according to claim 10, wherein the positioning system is one of a Global Positioning System and an Assisted Global Positioning System.
